(19) United States
(12) Patent Application Publication
(10) Pub. No.: US 2016/0222691 A1
(43) Pub. Date: Aug. 4, 2016

(54) Screen canopy for zero turn mower

(71) Applicant: Clarence Williams, JR., Junction City, KS (US)

(72) Inventor: Clarence Williams, JR., Junction City, KS (US)

(21) Appl. No.: 15/010,259

(22) Filed: Jan. 29, 2016

Related U.S. Application Data
(60) Provisional application No. 62/109,462, filed on Jan. 29, 2015.

(51) Int. Cl. E04H 15/06; A01D 75/20; A01D 34/00

(52) U.S. Cl. CPC E04H 15/06; A01D 34/001; A01D 75/20; A01D 2101/00

(57) ABSTRACT

A screen canopy for a zero turn mower protects the user from insects and flying debris while operating the mower. The canopy is lightweight and easily installed, but sturdy enough to prevent damage when moving closely past trees, hedges, and other vegetation.

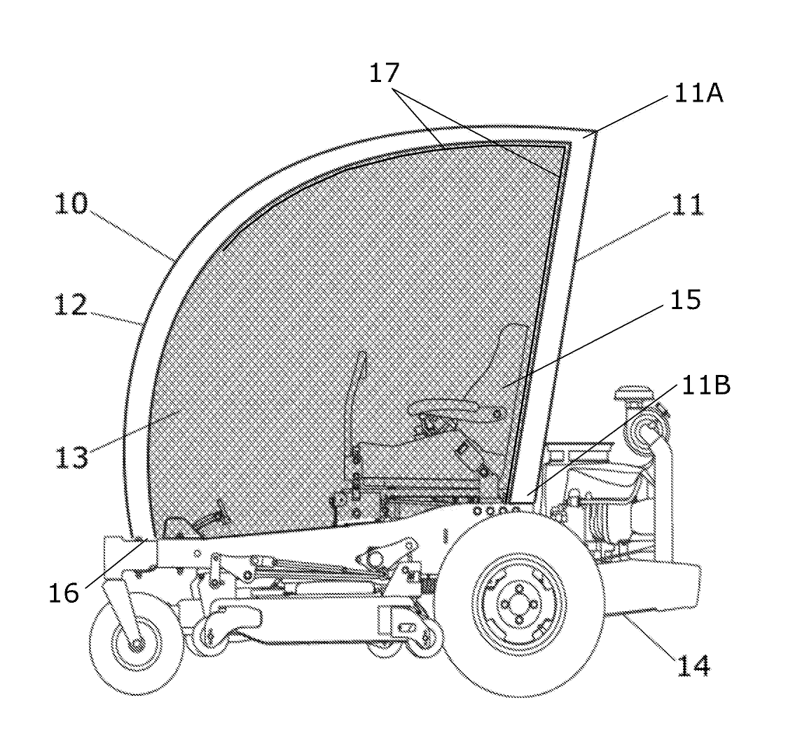

### CROSS-REFERENCE TO RELATED APPLICATIONS

This application claims the benefit of U.S. Provisional Application No. 62/109,462, filed Jan. 29, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lawn care equipment and in particular to a screen canopy for a zero turn mower. Large scale lawn maintenance operations have been transformed by the zero turn mower, which is capable of rapidly mowing large areas while efficiently maneuvering around any obstacle. Unfortunately, the driver may spend an extended period of time on the mower and is vulnerable to insects and flying debris, such as twigs and gravel.

A search of the prior art reveals various attachments which have been developed to protect the driver from sun and rain. None are intended to protect the driver from insects and debris. None are closely related to the present invention, but several include features which resemble those of the present invention. Each has proven to be less than satisfactory in its own way. The present invention has been developed for the purpose of addressing and resolving these disadvantages. A screen canopy for a zero turn mower, which protects the driver from these hazards, would resolve this problem.

Protective cover for rotary lawn mower blade, U.S. Pat. No. 4,306,600 (priority Feb. 29, 1980), provides a protective device for sharpened cutting edges. A sheath apparatus adapted to be connected, and secured, to the opposite ends of a blade for a rotary lawn mower is described. The invention provides protection for the user thereof when attaching or detaching rotary lawn mower blades or during the sharpening of such blades.

Protective device for rotary lawn mower blade, U.S. Pat. No. 7,481,256 (priority Jul. 25, 2005), provides a protective device for a rotary lawn mower blade in the form of an open-ended envelope of flexible shape retaining material such as plastic. The envelope has a back panel and two overlapping front panels which are held together by means of a complemental bead and groove arrangement. Apertures are provided in the panels so that the protective device can be applied to the blade while the blade is attached to the lawn mower drive shaft. Trim indicia is also provided.

Guard means for rotary mowers, U.S. Pat. No. 4,216,643 (priority Aug. 26, 1977), provides a guard means for a rotary power mower of the type having a hollow base member, a horizontal blade rotatably mounted in the base member, the base member being adjustably elevated off the ground by a plurality of adjustable wheels. Guards are provided to prevent a person's foot from extending under the base member into contact with the blade. The guards are mounted around the periphery of the base member. The guards extend to close proximity with the ground.

Portable vehicle canopy, U.S. Pat. No. 7,255,121 (priority Feb. 20, 2004), provides a universal portable vehicle canopy unit for a front engine mower style vehicle and includes suction cup affixing to the rear fender for easy assembly and disassembly of the unit to the vehicle. The portable vehicle canopy framework is held upright by adjustable length straps. A flexible canopy framework cross beams. Main usage for the portable vehicle canopy would be to ward off light rain. Material of the canopy framework structure is light gauge aluminum bent tubing or plastic molded tubing.

Universal canopy for all riding lawn mowers, U.S. Pat. No. 5,232,005 (priority Feb. 4, 1991), provides a universal canopy for all riding mowers, including front and rear engine types. A horizontal base bolts onto an implement hitch. Two holes bored at the most distant point possible above said implement hitch depending on said riding lawn mower design is for two bolts that fasten adjustable tubes to said riding mower and secured to a vertical base for maximum strength and stability resulting in a three point mount. Adjustable sleeves on said vertical base move in a vertical manner plus special hinges attached on to said adjustable sleeves allow three hundred and sixty degree movement of said adjustable tubes to make said vertical base very universal. Also said adjustable tubes telescope in side of sleeves for adjustment and are secured in place by set screws to make said vertical base even more universal for all of said riding canopy telescopes inside two vertical tubes that serve as said vertical base to give the desired height of said canopy telescopes inside of adjustable sleeves fixed horizontally on a cross member joined to said tubing supports. All adjustable entities are secured in place by set screws. Said canopy is secured to said top frame by way of snaps.

Riding lawn mower canopy, U.S. Pat. No. 5,842,732 (priority Nov. 27, 1996), provides a canopy as an add-on attachment for riding lawn mowers which includes brackets mounting front and rear struts in front of and behind the mower canopy ring attached to the reinforcing skirt adds additional strength to the canopy. Braces prevent pivotal movement of the struts and canopy so that the canopy is easily installed and quickly removed or lowered as the need arises.

Most of these inventions secure a fabric or solid canopy, with large openings at the front and sides, to the body of a riding lawn mower. This leaves the driver exposed to insects, such as mosquitoes, and to debris, such as twigs and gravel. Many large scale grounds maintenance companies use multiple mowers on each lawn and thus a mower driven by one driver may hurl debris which injures the driver of a nearby mower. The present invention, which provides a screened canopy fully enclosing the driver, resolves the disadvantages of the prior art and is not anticipated by the prior art.

### SUMMARY OF THE INVENTION

Accordingly, the invention is directed to a screen canopy for a zero turn mower. The canopy protects the user from insects and flying debris while operating the mower. The canopy is lightweight and easily installed, but sturdy enough to prevent damage when moving closely past trees, hedges, and other vegetation. The canopy is easily folded and stores compactly.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a side view of the first exemplary embodiment mounted on a zero turn mower, displaying the canopy 10, a post 11, a frame 12, the mesh 13, and the mower 14.

### DETAILED DESCRIPTION OF THE INVENTION

Referring now to the invention in more detail, the invention is directed to a screen canopy 10 for a zero turn mower 14.

The invention is intended for installation as an after-market modification by the owner of the mower 14, or by a repair shop. As such, the canopy 10 would include means of attaching the canopy 10 to the mower 14. Those means may be bolts, screws, adhesives, or any other suitable attachment means commonly known in the art. An alternate embodiment, intended for installation as original equipment by the manufacturer of the mower 14, is also contemplated.

The first exemplary embodiment is comprised of a canopy 10 which protects the user from insects and flying debris while operating the mower 14. The canopy 10 is comprised of two posts 11 which arise behind the driver's seat 15 of the mower 14, two curved frames 12 which extend from the tops of the post 11 through a 120° arc to be secured to an area 16 near the pedals of the mower 14, and panels of mesh 13 which cover the posts 11 and frames 12 to create an enclosure.

The canopy 10 is easily folded and stores compactly. The canopy 10 is lightweight and easily installed, but sturdy enough to prevent damage when moving closely past trees, hedges, and other vegetation. Ingress and egress is preferably provided by securing the mesh 13 to the post 11 and upper part of the frame 12 on one side with zippers 17 or similar closures.

To use the first exemplary embodiment, the user sits on the seat of the mower 14, closes the mesh 13 with the closures which are provided, and proceeds to operate the mower 14.

The posts 11 and the frames 12 are preferably manufactured from a rigid, durable material which is lightweight and corrosion resistant, such as plastic or aluminum alloy. The mesh 13 is preferably manufactured from a flexible, durable material such as nylon.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A screen canopy, comprising two posts having a top and a bottom; said bottoms of the posts being attached to a riding lawn mower behind a driver's seat; two curved frames; said curved frames extending from said top of the posts to an area around the pedals of the riding lawn mower; and a plurality of panels; said panels being made of mesh and covering the posts and frames to form an enclosure.

2. The screen canopy of claim 1, wherein said mesh is fine enough to repel insects and flying debris.

3. The screen canopy of claim 1, wherein said curved frames follow a 120 degree arc from said top of the posts to the area around the pedals of the riding lawn mower.

4. The screen canopy of claim 2, wherein said curved frames follow a 120 degree arc from said top of the posts to the area around the pedals of the riding lawn mower.

5. The screen canopy of claim 1, wherein the screen canopy is removable and is configured to easily fold upon itself after removal such that said canopy may be stored compactly.

6. The screen canopy of claim 2, wherein the screen canopy is removable and is configured to easily fold upon itself after removal such that said canopy may be stored compactly.

7. The screen canopy of claim 1, further comprising an opening; said opening being formed on a side wall of the enclosure by securing the mesh to the post and upper part of the frame on one side with zippers or similar closures.

8. The screen canopy of claim 2, further comprising an opening; said opening being formed on a side wall of the enclosure by securing the mesh to the post and upper part of the frame on one side with zippers or similar closures.

9. The screen canopy of claim 1, further comprising means for attaching said screen canopy to said riding lawn mower as an aftermarket accessory.

10. The screen canopy of claim 1, wherein the screen canopy is attached to the riding law mower as original equipment by a manufacturer of the riding lawn mower.

11. The screen canopy of claim 2, further comprising means for attaching said screen canopy to said riding lawn mower as an aftermarket accessory.

12. The screen canopy of claim 2, wherein the screen canopy is attached to the riding law mower as original equipment by a manufacturer of the riding lawn mower.

13. The screen canopy of claim 1, wherein the posts and frames are manufactured from a rigid, lightweight, and durable material which is corrosion resistant, such as plastic or aluminum alloy.

14. The screen canopy of claim 1, wherein the mesh is preferably manufactured from a flexible, durable material such as nylon.

15. The screen canopy of claim 2, wherein the posts and frames are manufactured from a rigid, lightweight, and durable material which is corrosion resistant, such as plastic or aluminum alloy.

16. The screen canopy of claim 2, wherein the mesh is preferably manufactured from a flexible, durable material such as nylon.
